(19) United States
(12) Patent Application Publication
(10) Pub. No.: US 2019/0347533 A1
(43) Pub. Date: Nov. 14, 2019

(54) Identification protection card

(71) Applicant: Ya-Yi Wang, Taichung (TW)

(72) Inventor: Ya-Yi Wang, Taichung (TW)

(21) Appl. No.: 16/524,200

(22) Filed: Jul. 29, 2019

(51) Int. Cl. G06K 19/073; G06K 19/07; G06K 19/077

(52) U.S. Cl. CPC G06K 19/07327; G06K 19/07728; G06K 19/0723

(57) ABSTRACT

An identification protection card is an identification card and includes a card body. The card body consists of a shielding metal sheet and two hard insulating protective layers configured to cover upper and lower surfaces of the shielding metal sheet. The card body is sized relative to an international standard chip card. A surface of at least one of the protective layers is printed with a logo, totem or character. When a chip card is inserted into a card compartment of a wallet, the identification card is placed close to one side of the chip card, thereby providing a shielding effect for the chip card. This effectively blocks the transmission and reception of electronic signals or electromagnetic waves outside the wallet, preventing the data of the chip card from being recorded.

### FIELD OF THE INVENTION

The present invention relates to an identification protection card. When a chip card (RFID proximity card) is inserted into a card compartment of a wallet, the identification protection card is placed close to one side of the chip card, thereby providing a shielding effect for the chip card. This effectively blocks the transmission and reception of electronic signals or electromagnetic waves outside the wallet, preventing the data of the chip card from being recorded.

### BACKGROUND OF THE INVENTION

A conventional identification card is a hard plastic card with colored or non-colored character information and patterns printed on its outer surface as a membership card, VIP card, consumer card and so on for recognizing an identity or for transmitting different information. However, the conventional card has no special functions (such as shielding sub-signals or electromagnetic waves) except for direct visual communication of information and identification, so the additional economic value of the cards cannot be improved.

Radio Frequency Identification (RFID) systems are widely used in everyday life, such as mobile phones, passports, bank cards and credit cards. When the user uses a credit card for payment, the RFID chip of the credit card needs to be sensed by a signal sensor, and the information of the user can be known through the data identification of the signal sensor to determine whether it is a legitimate user identity. When the determination is correct, the credit card can be used for payment. This is convenient and time-saving, without change.

With the expansion of the RFID applications, most people usually have at least one RFID proximity card. For carrying conveniently, multiple RFID proximity cards are often placed in the wallet and taken out when needed. Most users place the wallet in the pocket of the trousers or in an easy-to-access place. When an illegitimate person uses a smart scanner or a mobile phone with a NFC module to read the cards, the data of the RFID proximity card in the wallet will be recorded. The personal information inside the RFID proximity card is stolen, resulting in the user's identity or the RFID proximity card being copied by the illegitimate person, and causing personal data or financial loss.

Accordingly, the inventor of the present invention has devoted himself based on his many years of practical experiences to solve these problems.

### SUMMARY OF THE INVENTION

The primary object of the present invention is to provide an identification protection card. The identification protection card is an identification card and comprises a card body. The card body consists of a shielding metal sheet and two hard insulating protective layers configured to cover upper and lower surfaces of the shielding metal sheet. The card body is sized relative to an international standard chip card.

Preferably, the protective layers are made of a polymer material for protecting the identification card. Preferably, a surface of at least one of the protective layers is printed with a logo, totem or character, so that the identification card of the invention has the function of identification.

Preferably, the shielding metal sheet has a thickness of at least 0.15 mm to block the transmission and reception of external electronic signals or electromagnetic waves, thereby achieving a good effect for shielding the chip card.

### BRIEF DESCRIPTION OF THE DRAWINGS

FIG. 1 is a schematic view of the present invention;

FIG. 2 is a cross-sectional view taken along line 2-2 of FIG. 1;

FIG. 2A is an enlarged view of circle A of FIG. 2;

FIG. 3 is a schematic view showing the operation of the present invention when in use;

FIG. 4 is a first perspective view of the present invention when in use;

FIG. 5 is a second perspective view of the present invention when in use; and

FIG. 6 is a schematic view of the present invention used to block external electronic signals or electromagnetic waves.

### DETAILED DESCRIPTION OF THE PREFERRED EMBODIMENTS

Embodiments of the present invention will now be described, by way of example only, with reference to the accompanying drawings.

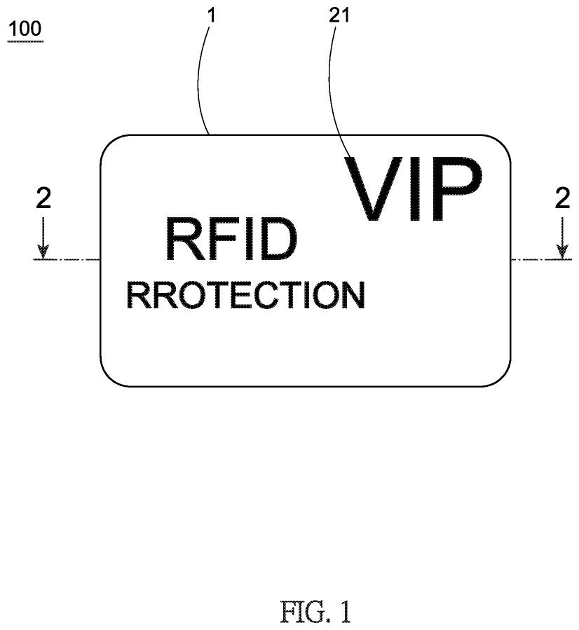

Referring to FIG. 1 to FIG. 3, the present invention discloses an identification protection card that is an identification card 100 and comprises a card body 1. The card body 1 consists of a shielding metal sheet 10 and two hard insulating protective layers 20 configured to cover upper and lower surfaces of the shielding metal sheet 10. The card body 1 is sized relative to an international standard chip card.

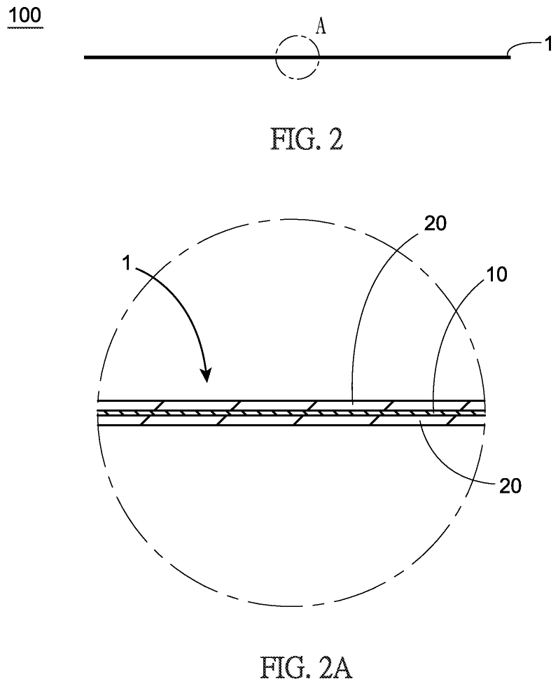

Referring to FIG. 2A, the shielding metal sheet 10 is a sheet of aluminum foil or copper foil, which is a shielding material to block (shield) the transmission of electromagnetic signals from electronic products. The greater the thickness of the shielding metal sheet 10, the more significant the shielding effect. Preferably, the shielding metal sheet 10 has a thickness of 0.15 mm to 0.3 mm to block the transmission and reception of external electronic signals or electromagnetic waves, thereby achieving a good effect for shielding the chip card.

In this embodiment, the size of the card body 1 is based on the international ISO7810 ID-1 format, with a width of 85.6 mm, a height of 53.98 mm, and a thickness of 0.76 mm.

Furthermore, the protective layer 20 is an insulating hard layer made of a polymer material (such as PC, ABS or acrylic) to make the identification card 100 durable and achieve high economic benefits.

In addition, the surface of the protective layer 20 may be printed with at least one logo, totem or character 21, so that the identification card 100 of the present invention has the function of identification.

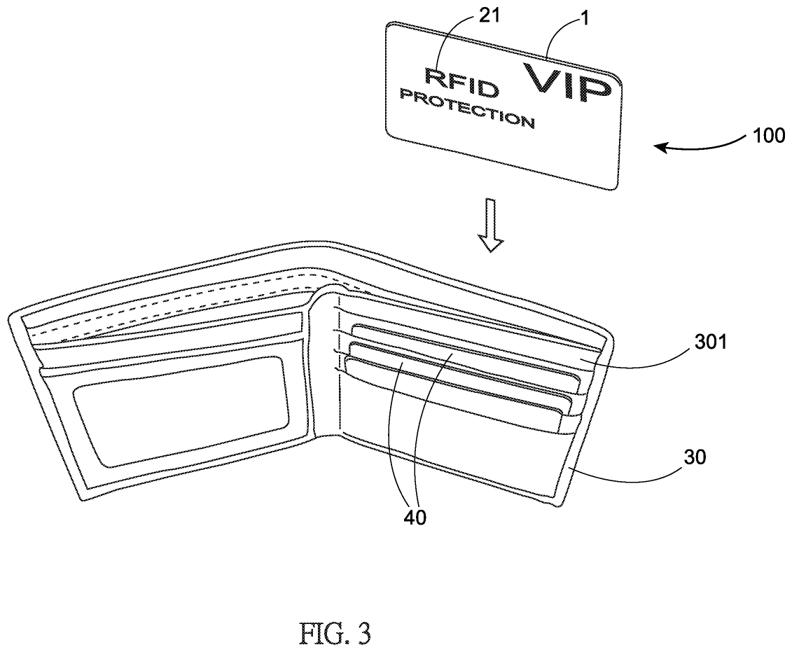

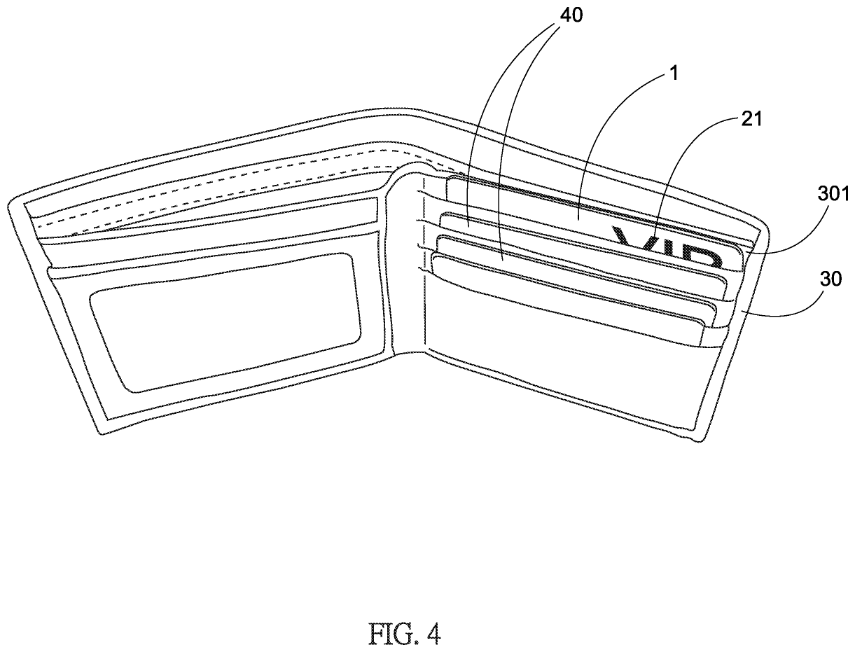

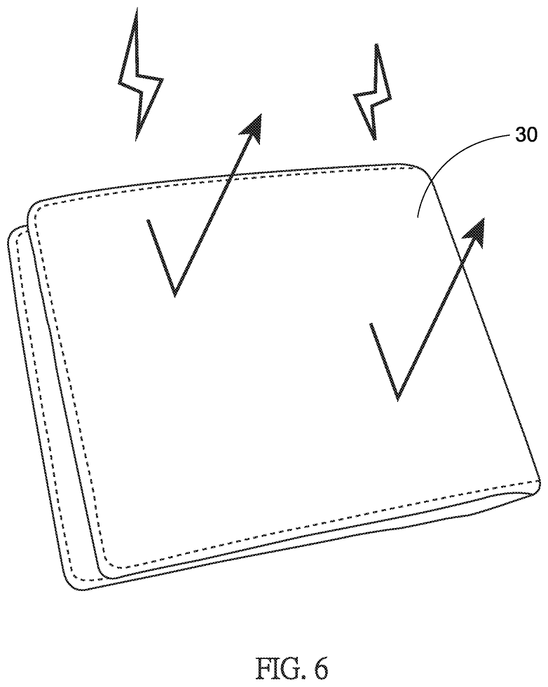

Referring to FIG. 3 and FIG. 4, in detail, when a chip card 40 is inserted into a card compartment 301 of a wallet 30, the identification card 100 is placed close to one side of the chip card 40, thereby providing a shielding effect for the chip card 40. This effectively blocks the transmission and reception of electronic signals or electromagnetic waves outside the wallet 30 (as shown in FIG. 6), preventing the data of the chip card 40 from being recorded.

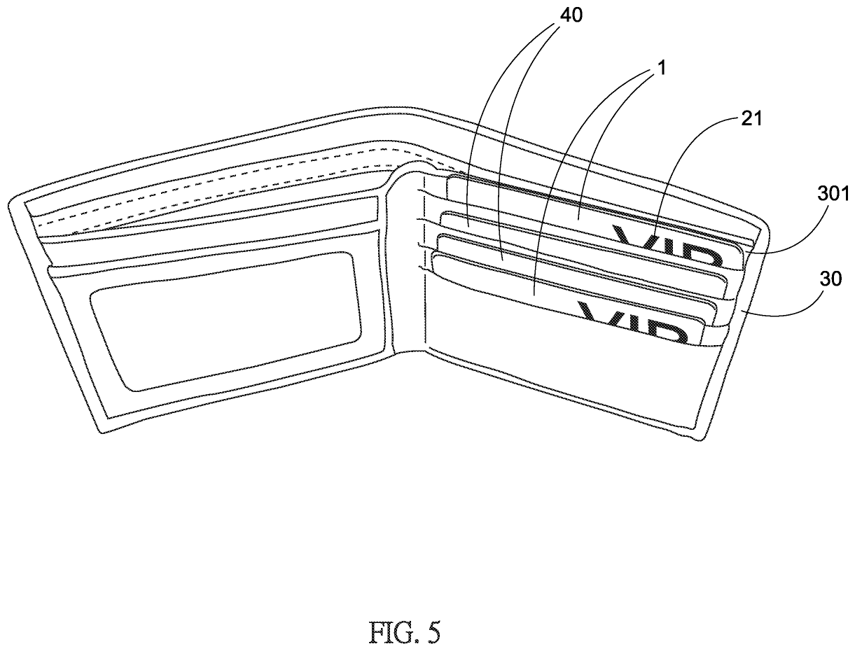

Finally, referring to FIG. 3 and FIG. 5, preferably, when a chip card 40 is inserted into a card compartment 301 of a wallet 30, two identification cards 100 are placed close to both sides of the chip card 40, thereby providing a full shielding effect for the chip card 40. This completely blocks the transmission and reception of electronic signals or electromagnetic waves outside the wallet 30 (as shown in FIG. 6), preventing the data of the chip card 40 from being recorded.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An identification protection card, being an identification card and comprising a card body, the card body consisting of a shielding metal sheet and two hard insulating protective layers configured to cover upper and lower surfaces of the shielding metal sheet, the card body being sized relative to an international standard chip card.

2. The identification protection card as claimed in claim 1, wherein the shielding metal sheet is a sheet of aluminum foil or copper foil.

3. The identification protection card as claimed in claim 1, wherein the shielding metal sheet has a thickness of at least 0.15 mm.

4. The identification protection card as claimed in claim 1, wherein the card body has a width of 85-87 mm, a height of 52-54 mm, and a thickness of 0.7-0.8 mm.

5. The identification protection card as claimed in claim 1, wherein the protective layers are made of a polymer material.

6. The identification protection card as claimed in claim 1, wherein a surface of at least one of the protective layers is printed with a logo, totem or character.
